(19) United States
(12) Patent Application Publication
(10) Pub. No.: US 2023/0147558 A1
(43) Pub. Date: May 11, 2023

(54) NEGATIVE ELECTRODE MATERIAL AND METHOD OF PREPARING THE SAME

(71) Applicants: Microvast Power Systems Co., Ltd., Huzhou (CN); Microvast, Inc., Stafford, TX (US)

(72) Inventors: Ting GUO, Huzhou (CN); Xianglian WANG, Huzhou (CN); Xiao ZHANG, Huzhou (CN); Jiangping YI, Huzhou (CN); Wenjuan Liu MATTIS, Longwood, FL (US)

(73) Assignees: Microvast Power Systems Co., Ltd., Huzhou (CN); Microvast, Inc., Stafford, TX (US)

(21) Appl. No.: 17/521,882

(22) Filed: Nov. 9, 2021

(51) Int. Cl. H01M 4/583; H01M 4/04; H01M 10/0525; H01M 4/133

(52) U.S. Cl. CPC H01M 4/583; H01M 4/0471; H01M 10/0525; H01M 4/133; H01M 2004/027

(57) ABSTRACT

A negative electrode material includes a dopant containing a first dopant and a second dopant, the first dopant contains a boron element, and the second dopant contains at least one selected from a group consisting of a nitrogen element, an oxygen element, a fluorine element, a phosphorus element, and a sulfur element. Two or more types of dopants are added in the particle producing process, so that the negative electrode material prepared has excellent high and low temperature cycle performance and rate performance. Furthermore, a carbonization coating process is omitted which is compatible with the preparation process of the conventional graphite negative electrode, thus the preparation process is simpler, the equipment required is less, and the cost is lower. A preparation method thereof is provided as well.

### TECHNICAL FIELD

The invention relates to the technical field of lithium-ion batteries, in particular to a negative electrode material with excellent high and low temperature cycle performance and rate performance and a preparation method thereof.

### BACKGROUND

In the recent 20 years, lithium-ion batteries as a new energy industry have been developing rapidly. With the broadening of the application field of lithium-ion batteries and the rapid increase in usage, higher and higher performance requirements for lithium-ion batteries, such as larger charging and discharging rates and wider operating temperature ranges, are demanded.

At present, the material used for the negative electrode of lithium-ion batteries is mainly graphite, which usually has usage temperature of room temperature. When the usage temperature is low, the impedance of the lithium-ion battery is greatly increased, which causes the low-temperature performance, especially the low-temperature charge ability, to be greatly reduced. In order to improve the low temperature performance of graphite, a layer of amorphous carbon is usually coated on the graphite surface to improve the diffusivity of lithium ions in the material. After the coating, the low-temperature performance of graphite is significantly improved, and the charging performance at room temperature is also significantly improved. In the prior art, nitrogen is further doped during the coating process, so that the rate performance of the negative electrode material is further improved. However, if the temperature is high, the coating layer is easily to react with the electrolyte during the process of intercalation and deintercalation of lithium ions, and the electrolyte is quickly consumed, causing the capacity of the lithium battery to rapidly decay. In addition, side reactions are easier at high temperatures after coating the amorphous carbon that means the capacity of the lithium battery decays faster. On the other hand, nitrogen doping may also bring problems such as a decrease in graphitization degree and a decrease in material capacity.

Therefore, how to simultaneously ensure good high and low temperature cycle performance and rate performance has become an important issue for the application prospects of lithium-ion batteries.

### SUMMARY OF THE INVENTION

In view of the foregoing, this present invention relates to a negative electrode material with excellent high and low temperature cycle performance and rate performance.

Additionally, the present invention relates to a method of preparing a negative electrode material with excellent high and low temperature cycle performance and rate performance.

Optionally, in some cases, a negative electrode material, comprising a dopant including a first dopant and a second dopant, the first dopant containing a boron element, and the second dopant containing at least one selected from a group consisting of a nitrogen element, an oxygen element, a fluorine element, a phosphorus element, and a sulfur element.

Raw material of the first dopant is a boron compound, and raw material of the second dopant is at least one selected from a group consisting of a nitrogen compound, an oxygen compound, a fluorine compound, phosphorus compound and sulfur compound.

Due to the two types of dopants being added in the particle producing process, the negative electrode material prepared has excellent high and low temperature cycle performance and rate performance. Furthermore, a carbonization coating process is omitted in the present invention, which is compatible with the preparation process of the conventional graphite negative electrode, thus the preparation process is simpler, the equipment required is less, and the cost is lower.

In some cases, the raw material of the first dopant is at least one selected from a group consisting of boric acid, boron oxide and tetraphenylboronic acid; the raw material of the second dopant is at least one selected from a group consisting of phosphoric acid, phosphorus pentoxide, ethylene diamine, ammonium dihydrogen phosphate, diammonium hydrogen phosphate, urea, ammonia, melamine, and phosphazene.

Accordingly, the present invention provides a method of preparing the above-mentioned negative electrode material, the method includes providing a mixture of a graphite material precursor, raw material of a dopant and a binder; proceeding a heating treatment to the mixture to obtain a reaction product; and graphitizing the reaction product to obtain the negative electrode material.

The raw material of the dopant includes raw material of a first dopant which is a boron compound.

In some cases, the raw material of the dopant includes raw material of a second dopant which is at least one selected from a group consisting of a nitrogen compound, an oxygen compound, a fluorine compound, phosphorus compound and sulfur compound.

The mixture is heated in a protective atmosphere, and the heating treatment includes stirring and heating the mixture to a first temperature and keeping the first temperature; and stirring and heating the mixture to the second temperature and keeping the second temperature. After the heating treatment, the reaction products can be obtained by natural cooling.

The negative electrode material obtained after graphitization is then crushed and sieved, and after being crushed and sieved, the negative electrode material has a median particle size of 1-50 microns, or 3-20 microns.

The graphite material precursor comprises at least one selected from a group consisting of petroleum coke, coal coke, pitch coke, pitch, soft carbon, hard carbon, needle coke, artificial graphite, natural graphite, mescarbon microbeads green pellets, and mescarbon microbeads (MCMB). For better processing performance and rate performance of the negative anode (final product), the graphite material precursor has a particle size of 0.5-20 microns, or 3-10 microns

The binder comprises at least one selected from a group consisting of pitch, petroleum resin, phenolic resin, coumarone resin, polyvinyl alcohol, polypropylene glycol, polyacrylic acid and polyvinyl butyral ester, and a mass ratio of the binder and the graphite material precursor is 0.1-20:100, or 1-10:100, or 2-5:100. The binder can be the same substance as the graphite material precursor, such as pitch. When the binder is served as the graphite material precursor at the same time, the mass ratio of the binder to other graphite material precursors is 10-100:100. Such a ratio is conducive to the graphite granulation and coating thereby improving the cycle performance.

The raw material of the dopant comprises raw material of a first dopant and raw material of a second dopant, a mass ratio of the raw material of the first dopant or the raw material of the second dopant and the graphite material precursor is 0.1-15:100, or 0.5-5:100. The median particle size of the raw material of the dopant is 0.01-10 micrometers, or 0.3-3 micrometers. The size of the raw material of the dopant is smaller, it is easier to enter into the graphite lattice to achieve the doping effect and obtain an improved doping uniformity. However, if the size is too small, the preparation cost is higher, and the dispersion is more difficult. The above-mentioned particle size can ensure uniform doping and improve dispersibility.

The protective atmosphere is an inert atmosphere, including one or a combination of argon, nitrogen, helium, and argon-hydrogen mixture.

The first temperature is 80-400° C., and a first temperature keeping time is 0.5-6 hours. Or, the first temperature is 120-350° C., and the first temperature keeping time is 1-3 hours.

The first temperature is higher than the softening point of the binder, so that the binder can be transformed into a glue liquid state. In this state, the binder has better adhesion, which can achieve an improved granulation effect, improve the anisotropy of the negative electrode material and reduce the expansion, thereby improving the cycle performance. In addition, in this state, the binder has a certain fluidity which can repair some defects on the surface of the graphite material precursor and reduce the specific surface area of the material, thereby improving the processing performance of the negative electrode material. Furthermore, the raw materials of the dopant are dispersed in the flowable binder, and uniformly dispersed on the surface of the graphite material precursor along with the flow of the binder, which is beneficial to improve the uniformity and stability of the doping.

The second temperature is 300-700° C., and a second temperature keeping time is 1-12 hours. Or, the second temperature is 400-600° C., and the second temperature keeping time is 1-12 hours. The second temperature is higher than the coking temperature of the binder, which causes the binder to solidify due to decomposition or recombination, thereby preventing it from being transformed into a glue liquid state under a subsequent heating or cooling condition.

The reaction product is graphitized under a temperature of 2500-3300° C.

The present invention adds two types of dopants in the particle producing process, so that the negative electrode material prepared has excellent high and low temperature cycle performance and rate performance. Furthermore, a carbonization coating process is omitted in the present invention, which is compatible with the preparation process of the conventional graphite negative electrode, thus the preparation process is simpler, the equipment required is less, and the cost is lower.

### DETAILED DESCRIPTION OF ILLUSTRATED EMBODIMENTS

In order to make the technical problems solved by the present invention, technical solutions, and beneficial effects clearer, the following further describes the present invention in detail with reference to embodiments. It should be understood that the specific embodiments described here are only used to explain the present invention, but not used to limit the present invention.

### Example 1

10 kg of a petroleum coke with a median particle size of 7 microns, 0.3 kg of a high-temperature pitch (adhesive), 0.3 kg of a boric acid, and 0.2 kg of a urea were mixed and then transferred to a thermal compounding apparatus, in which a nitrogen atmosphere was introduced then. Then the mixture was stirred and heated to 340° C. and kept for 2 h, then stirred and heated to 550° C. and kept for 3 h, and then naturally cooled. A reaction product obtained was graphitized under a treatment temperature of about 2800° C. The graphitized product was then crushed and sieved through a 400-mesh sieve to finally obtain a negative electrode material with a median particle size of 13 microns.

### Comparative Example 1.1

10 kg of a petroleum coke with a median particle size of 7 microns and 0.3 kg of a high-temperature pitch were mixed and then transferred to a thermal compounding apparatus, in which a nitrogen atmosphere was introduced then. Then the mixture was stirred and heated to 340° C. and kept for 2 h, then stirred and heated to 550° C. and kept for 3 h, and then naturally cooled. A reaction product obtained was graphitized under a treatment temperature of about 2800° C. The graphitized product was then crushed and sieved through a 400-mesh sieve to finally obtain a negative electrode material with a median particle size of 13 microns.

### Comparative Example 1.2

10 kg of a petroleum coke with a median particle size of 7 microns, 0.3 kg of a high-temperature pitch and 0.3 kg of a boric acid were mixed and then transferred to a thermal compounding apparatus, in which a nitrogen atmosphere was introduced then. Then the mixture was stirred and heated to 340° C. and kept for 2 h, then stirred and heated to 550° C. and kept for 3 h, and then naturally cooled. A reaction product obtained was then graphitized under a treatment temperature of about 2800° C. The graphitized product was then crushed and sieved through a 400-mesh sieve to finally obtain a negative electrode material with a median particle size of 13 microns.

### Example 1.3

10 kg of a petroleum coke with a median particle size of 7 microns, 0.3 kg of a high-temperature pitch and 0.2 kg of a urea were mixed and then transferred to thermal compounding equipment, in which a nitrogen atmosphere was introduced then. Then the mixture was stirred and heated to 340° C. and kept for 2 h, then stirred and heated to 550° C. and kept for 3 h, and then naturally cooled. A reaction product obtained was then graphitized under a treatment temperature of about 2800° C. The graphitized product was then crushed and sieved through a 400-mesh sieve to finally obtain a negative electrode material with a median particle size of 13 microns.

### Example 2

10 kg of a needle coke with a median particle size of 8 microns, 0.5 kg of a coumarone resin, 0.2 kg of a boron oxide, and 0.4 kg of a diammonium hydrogen phosphate were mixed and transferred to a thermal compound apparatus, in which a nitrogen atmosphere was introduced then. Then the mixture was stirred and heated to 260° C. and kept for 1.5 h, then stirred and heated to 600° C. and kept for 4 h, and then naturally cooled. A reaction product obtained was graphitized under a temperature of about 3000° C. The graphitized product was then crushed and sieved through a 300-mesh sieve to finally obtain a negative electrode material with a median particle size of 16 microns.

### Comparative Example 2.1

10 kg of a needle coke with a median particle size of 8 microns and 0.5 kg of a coumarone resin were mixed and transferred to a thermal compound apparatus, in which a nitrogen atmosphere was introduced then. Then the mixture was stirred and heated to 260° C. and kept for 1.5 h, then stirred and heated to 600° C. and kept for 4 h, and then naturally cooled. A reaction product obtained was graphitized under a temperature of about 3000° C. The graphitized product was then crushed and sieved through a 300-mesh sieve to finally obtain a negative electrode material with a median particle size of 16 microns.

### Comparative Example 2.2

10 kg of a needle coke with a median particle size of 8 microns, 0.5 kg of a coumarone resin and 0.2 kg of a boron oxide were uniformly mixed and transferred to a thermal compound apparatus, in which a nitrogen atmosphere was introduced then. Then the mixture was stirred and heated to 260° C. and kept for 1.5 h, then stirred and heated to 600° C. and kept for 4 h, and then naturally cooled. A reaction product obtained was graphitized under a temperature of about 3000° C. The graphitized product was then crushed and sieved through a 300-mesh sieve to finally obtain a negative electrode material with a median particle size of 16 microns.

### Example 2.3

10 kg of a needle coke with a median particle size of 8 microns, 0.5 kg of a coumarone resin and 0.4 kg of a diammonium hydrogen phosphate were uniformly mixed and transferred to a thermal compound apparatus, in which a nitrogen atmosphere was introduced then. Then the mixture was stirred and heated to 260° C. and kept for 1.5 h, then stirred and heated to 600° C. and kept for 4 h, and then naturally cooled. A reaction product obtained was graphitized under a temperature of about 3000° C. The graphitized product was then crushed and sieved through a 300-mesh sieve to finally obtain a negative electrode material with a median particle size of 16 microns.

### Example 3

7.5 kg of natural graphite with a median particle size of 6 microns, 2.5 kg of pitch, 0.01 kg of a boron oxide, and 0.05 kg of a melamine were mixed and then transferred to a thermal compound apparatus, in which a nitrogen atmosphere was introduced then. Then the mixture was stirred and heated to 340° C. and kept for 3 h, then stirred and heated to 650° C. and kept for 1 h, and then naturally cooled. A reaction product obtained was graphitized under a temperature of about 2700° C. The graphitized product was then crushed and sieved through a 300-mesh sieve to finally obtain a negative electrode material with a median particle size of 20 microns.

### Example 4

10 kg of a pitch coke with a median particle size of 3 microns, 0.8 kg of a petroleum resin, 0.8 kg of a tetraphenylboric acid, 0.3 kg of a boric acid, 0.9 kg of a phosphoric acid and 0.3 kg of an ethylenediamine were mixed and then transferred to a thermal compound apparatus, in which a nitrogen atmosphere was introduced then. Then the mixture was stirred and heated to 100° C. and kept for 6 h, then stirred and heated to 360° C. and kept for 12 h, and then naturally cooled. A reaction product obtained was graphitized under a temperature of about 3200° C. The graphitized product was then crushed and sieved through a 400-mesh sieve to finally obtain a negative electrode material with a median particle size of 5 microns.

Battery Preparation Procedure

NCM523, conductive agent, and adhesive PVDF at a weight ratio of 95:2.5:2.5 were mixed in NMP and then stirred to make positive electrode slurry which was then coated onto both sides of a positive electrode current collector, and then dried to obtain a positive plate.

The negative electrode material in each example or comparative example, styrene-butadiene rubber (SBR), carboxyl methyl cellulose (CMC) and conductive agent Super-P at a weight ratio of 94:2.5:2:1.5 were respectively mixed in deionized water and then stirred to make negative electrode slurry which was then coated on both sides of a negative electrode current collector, and then dried to obtain a negative plate.

The current collector in each embodiment and each comparative example used the same foil material, the contents of active material for per unit area of the positive and negative plate were the same, and the coating length and width of the positive and negative plates were the same. Further, the same electrolyte was used, specifically, the composition of the electrolyte solvent was set to DMC:EC:DEC=1:1:1 in a volume ratio, 1 mol/L LiPF₆ lithium salt was contained, and 0.5% VC was also contained by mass.

Battery Production

Pouch cell production: assembling the negative plate and positive plate prepared according to the foregoing process with a polyethylene separator to prepare a battery cell, packing the battery cell in an outer package, injecting electrolyte and sealing the outer package, then pre-charging and performing a formation process to obtain a lithium-ion secondary pouch cell. The battery capacity is about 5 Ah.

Coin cell production: using NMP to wipe off coated material on one side of the negative plate prepared according to the foregoing process, and then drying and cutting to produce a 2032 coin cell.

Battery Test Method

Coin cell: used to test gram capacity of the corresponding coin cell of different samples. The test voltage range is 1.5-0.005V, constant current and constant voltage discharge is applied, the constant current discharge rate is 0.1 C, the constant voltage discharge cut-off current is 0.01 C, and the constant current charge rate is 0.05 C.

Pouch cell: used to test charge and discharge performance of the battery. At 25±±2° C., the constant current ratio for the corresponding pouch cell of different samples under 3 C rate charging is tested. The DC internal resistance (DCR) for different samples under 50% SOC and 5 C rate charging is tested. Further, the cycle retention rate for different samples respectively at 10° C., 25° C. and 45° C. is tested, specifically, the charge-discharge rate at 25° C. and 45° C. is 1 C., and the charge-discharge rate at −10° C. is 0.5 C; and the voltage range for the cycle test is 4.3-2.7V.

The test results were shown in Table 1 below.

TABLE 1

| | | 3C | | | | |
|---|---|---|---|---|---|---|
| | | charge | | | | |
| | | constant | | Capacity retention rate (%) | | |
| | Gram | current | | −10° C., | 25° C., | 45° C., |
| | capacity | ratio | DCR | for 300 | for 1000 | for 800 |
| Sample | (mAh/g) | (%) | (mΩ) | cycles | cycles | cycles |
| Example 1 | 346.2 | 85.6 | 7.4 | 99.8 | 88.0 | 84.7 |
| Comparative | 345.4 | 81.5 | 8.9 | 70.4 | 87.8 | 82.8 |
| Example 1.1 | | | | | | |
| Comparative | 346.1 | 83.8 | 7.9 | 90.5 | 87.8 | 84.6 |
| Example 1.2 | | | | | | |
| Example 1.3 | 342.8 | 85.0 | 7.6 | 99.2 | 87.0 | 80.6 |
| Example 2 | 351.9 | 84.8 | 7.9 | 99.6 | 85.5 | 84.5 |
| Comparative | 351.2 | 80.2 | 9.7 | 53.5 | 85.2 | 82.4 |
| Example 2.1 | | | | | | |
| Comparative | 352.1 | 83.0 | 8.4 | 85.9 | 85.3 | 84.3 |
| Example 2.2 | | | | | | |
| Example 2.3 | 349.7 | 84.3 | 8.1 | 98.9 | 84.9 | 80.5 |
| Example 3 | 363.4 | 84.4 | 8.2 | 98.9 | 84.6 | 82.1 |
| Example 4 | 331.5 | 87.3 | 6.9 | 99.7 | 87.1 | 83.5 |

From the comparisons between Example 1 and Comparative Example 1.1, between Example 2 and Comparative Example 2.1, in comparison with the undoped negative electrode material, the battery using the negative electrode material of the present invention can obtain the increased 3 C constant current ratio and reduced DCR, indicating that the rate performance is improved; and can obtain significantly increased low-temperature cycle capacity retention rate and the slightly increased high-temperature cycle capacity retention rate, indicating that the high and low temperature performance is improved. From the comparisons between Example 1 and Comparative Example 1.2, between Example 2 and Comparative Example 2.2, in comparison with the negative electrode material doped with boron alone, the battery using the negative electrode material of the present invention can obtain the increased 3 C constant current ratio and reduced DCR, indicating that the rate performance is improved; and can obtain higher low-temperature cycle capacity retention rate, indicating that the low-temperature cycle performance is better. From the comparisons between Example 1 and Example 1.3, between Example 2 and Example 2.3, in comparison with the negative electrode material doped with a single second dopant, the battery using negative electrode material doped with two kinds of dopants can obtain lower DCR and higher low-temperature cycle capacity retention rate, specially the high-temperature cycle capacity retention rate is increased significantly, indicating that the high-temperature cycle performance of negative electrode materials with two kinds of dopants is better.

In comparison with the prior art, the present invention adds two types of dopants in the particle producing process, so that the negative electrode material prepared has excellent high and low temperature cycle performance and rate performance. Furthermore, a carbonization coating process is omitted in the present invention, which is compatible with the preparation process of the conventional graphite negative electrode, thus the preparation process is simpler, the equipment required is less, and the cost is lower.

The above-mentioned embodiments do not constitute a limitation on the protection scope of the technical solution. Any modification, equivalent replacement and improvement made within the spirit and principle of the above-mentioned embodiments shall be included in the protection scope of the technical solution.

What is claimed is:

1. A negative electrode material, comprising a dopant including a first dopant and a second dopant, the first dopant containing a boron element, and the second dopant containing at least one selected from a group consisting of a nitrogen element, an oxygen element, a fluorine element, a phosphorus element, and a sulfur element.

2. The negative electrode material of claim 1, wherein raw material of the first dopant is a boron compound, and raw material of the second dopant is at least one selected from a group consisting of a nitrogen compound, an oxygen compound, a fluorine compound, phosphorus compound and sulfur compound.

3. The negative electrode material of claim 2, wherein the raw material of the first dopant is at least one selected from a group consisting of boric acid, boron oxide and tetraphenylboronic acid; the raw material of the second dopant is at least one selected from a group consisting of phosphoric acid, phosphorus pentoxide, ethylene diamine, ammonium dihydrogen phosphate, diammonium hydrogen phosphate, urea, ammonia, melamine, and phosphazene.

4. A method of preparing the negative electrode material of claim 1, comprising:
providing a mixture of a graphite material precursor, raw material of a dopant, and a binder;
proceeding a heating treatment to the mixture to obtain a reaction product; and
graphitizing the reaction product to obtain the negative electrode material.

5. The method of claim 4, wherein the raw material of the dopant comprises raw material of a first dopant and raw material of a second dopant, the raw material of the first dopant is a boron compound, and raw material of the second dopant is at least one selected from a group consisting of a nitrogen compound, an oxygen compound, a fluorine compound, phosphorus compound and sulfur compound.

6. The method of claim 4, wherein the mixture is heated in a protective atmosphere, and the heating treatment comprises:
stirring and heating the mixture to a first temperature and keeping the first temperature; and
stirring and heating the mixture to the second temperature and keeping the second temperature.

7. The method of claim 4, wherein the negative electrode material obtained after graphitization is then crushed and sieved, and after being crushed and sieved, the negative electrode material has a median particle size of 1-50 microns.

8. The method of claim 4, wherein the graphite material precursor comprises at least one selected from a group consisting of petroleum coke, coal coke, pitch coke, pitch, soft carbon, hard carbon, needle coke, artificial graphite, natural graphite, mescarbon microbeads green pellets, and mescarbon microbeads.

9. The method of claim 4, wherein the binder comprises at least one selected from a group consisting of pitch, petroleum resin, phenolic resin, coumarone resin, polyvinyl alcohol, polypropylene glycol, polyacrylic acid and polyvinyl butyral ester, and a mass ratio of the binder and the graphite material precursor is 0.1-20:100.

10. The method of claim 4, wherein the raw material of the dopant comprises raw material of a first dopant and raw material of a second dopant, a mass ratio of the raw material of the first dopant or the raw material of the second dopant and the graphite material precursor is 0.1-15:100.

11. The method of claim 6, wherein the protective atmosphere is an inert atmosphere, including one or a combination of argon, nitrogen, helium, and argon-hydrogen mixture.

12. The method of claim 6, wherein the first temperature is 80-400° C., and a first temperature keeping time is 0.5-6 hours.

13. The method of claim 6, wherein the second temperature is 300-700° C., and a second temperature keeping time is 1-12 hours.

14. The method of claim 4, wherein the reaction product is graphitized under a temperature of 2500-3300° C.
